(19) United States
(12) Patent Application Publication
(10) Pub. No.: US 2018/0230276 A1
(43) Pub. Date: Aug. 16, 2018

(54) METHOD FOR MANUFACTURING WET RUBBER MASTERBATCH, METHOD FOR MANUFACTURING RUBBER COMPOSITION, AND METHOD FOR MANUFACTURING TIRE

(71) Applicant: TOYO TIRE & RUBBER CO., LTD., Itami-shi, Hyogo (JP)

(72) Inventor: Chiya Nishimura, Osaka-shi (JP)

(73) Assignee: TOYO TIRE & RUBBER CO., LTD., Itami-shi, Hyogo (JP)

(21) Appl. No.: 15/751,963

(22) PCT Filed: May 10, 2016
(86) PCT No.: PCT/JP2016/063920

§ 371 Date: Feb. 12, 2018

(30) Foreign Application Priority Data
Oct. 29, 2015 (JP) 2015-213035

(51) Int. Cl. C08J 3/22; C08J 3/215; C08L 7/02; C08K 3/04; C08K 3/32

(52) U.S. Cl. CPC C08J 3/22; C08J 3/215; C08L 7/02; C08L 2310/00; C08K 3/32; C08J 2307/02; C08K 3/04

(57) ABSTRACT

A method of manufacturing a wet rubber masterbatch includes preparing latex containing magnesium in an amount which is not greater than 150 ppm; and making a liquid mixture that includes a rubber component and carbon black. The latex may include rubber particles for which the 90 vol % particle diameter is not greater than 2 μm. The liquid mixture can be made by a step (a) in which the latex and a dispersion solvent are mixed; and a step (b) in which a latex solution obtained at step (a) and a slurry containing the carbon black are mixed. The method for manufacturing a wet rubber masterbatch may satisfy: 0.1<b/a<1.0, where a indicates amount (ppm) of magnesium present in latex; and b indicates amount (parts by mass) of carbon black in the liquid mixture for every 100 parts by mass of rubber component in the liquid mixture.

### TECHNICAL FIELD

The present invention relates to a method for manufacturing wet rubber masterbatch, method for manufacturing rubber composition, and method for manufacturing tire.

### BACKGROUND ART

Natural rubber latex is sometimes used as raw material for wet rubber masterbatch. Natural rubber latex contains nonrubber components; e.g., magnesium and the like.

The prior art references describe the following art. Described at Patent Reference No. 1 is art in which a wet masterbatch is manufactured by a method including an operation in which natural rubber latex and a slurry that contains carbon black having a 90 vol % particle diameter of not greater than 10 μm are mixed together. Described at Patent Reference No. 2 is art in which phosphate is added to natural rubber latex, and the magnesium phosphate which is produced as a result is removed therefrom. Described at Patent Reference No. 3 is art in which elemental magnesium present in natural rubber latex is removed therefrom.

### PRIOR ART REFERENCES

### Patent References

### PATENT REFERENCE NO. 1: Japanese Patent Application Publication Kokai No. 2010-150485

### PATENT REFERENCE NO. 2: Japanese Patent Application Publication Kokai No. 2004-250546

### PATENT REFERENCE NO. 3: WO2010/074245

### SUMMARY OF INVENTION

### Problem to be Solved by Invention

However, the art of the prior art references leaves room for improvement. The art of Patent Reference No. 1 lacks any stratagem for removal of magnesium. The art of Patent Reference Nos. 2 through 3 does not take the particle diameter of rubber particles into consideration.

The present invention was conceived in light of such situation, it being an object thereof to provide a method for manufacturing a wet rubber masterbatch that will serve as raw material for vulcanized rubber which excels in fatigue resistance, ability to achieve reduced heat generation, and tensile characteristics.

### Means for Solving Problem

The present inventor(s) came to the realization that fatigue resistance can be improved by reducing the amount of magnesium in latex. The present inventor(s) also discovered that processing to remove magnesium can have an effect on rubber particle diameter and that dispersion of carbon black throughout the wet rubber masterbatch becomes nonuniform—and ability to achieve reduced heat generation in the vulcanized rubber is made worse—when rubber particle diameter is too large. It was also discovered that the pre-coagulation amount of carbon black has an effect on tensile characteristics and so forth. The present inventor(s) perfected the present invention based on such knowledge.

That is, the present invention relates to a method for manufacturing a wet rubber masterbatch comprising an operation in which a latex that has magnesium present therein in an amount which is not greater than 150 ppm is prepared; and an operation in which a liquid mixture that comprises a rubber component and carbon black is made. The latex comprises rubber particles for which the 90 vol % particle diameter is not greater than 2 μm. The operation in which the liquid mixture is made comprises a step (a) in which the latex and a dispersion solvent are mixed; and a step (b) in which a latex solution obtained at the foregoing step (a) and a slurry containing the carbon black are mixed. The method for manufacturing a wet rubber masterbatch in accordance with the present invention satisfies Formula I, below.

0.1<b/a<1.0 (Formula I)

(At Formula I, a indicates amount (ppm) of magnesium present in latex; b indicates amount (parts by mass) of carbon black in the liquid mixture for every 100 parts by mass of rubber component in the liquid mixture.)

A method in accordance with the present invention permits manufacture of a wet rubber masterbatch that will serve as raw material for vulcanized rubber which excels in fatigue resistance, ability to achieve reduced heat generation, and tensile characteristics. This is likely due to the fact that under such conditions it is speculated there will be good dispersion of carbon black and there will be strong interaction between natural rubber and carbon black. It is speculated that under such conditions there will be few crack initiation sites present throughout the vulcanized rubber. When magnesium content exceeds 150 ppm, it is not possible to achieve effective improvement with respect to fatigue resistance. When 90 vol % particle diameter is greater than 2 μm, it will not be possible to achieve effective improvement with respect to reduction in heat generation. This is likely due to the fact that under such conditions it is speculated there would be nonuniform dispersion of carbon black. When b/a is greater than or equal to 1.0, it will not be possible to achieve effective improvement with respect to fatigue resistance, reduction in heat generation, and tensile characteristics. When b/a is less than or equal to 0.1, it will not be possible to achieve effective improvement with respect to fatigue resistance, reduction in heat generation, and tensile characteristics.

The present invention also relates to a rubber composition manufacturing method comprising a method for manufacturing a wet rubber masterbatch. A method in accordance with the present invention permits manufacture of a rubber composition that will serve as raw material for vulcanized rubber which excels in fatigue resistance, ability to achieve reduced heat generation, and tensile characteristics.

The present invention also relates to a tire manufacturing method comprising a rubber composition manufacturing method. A method in accordance with the present invention permits manufacture of a tire that excels in fatigue resistance, ability to achieve reduced heat generation, and tensile characteristics.

### EMBODIMENTS FOR CARRYING OUT INVENTION

### Embodiment 1

A method for manufacturing a wet rubber masterbatch associated with a first embodiment comprises an operation in which a latex is prepared, and an operation in which a liquid mixture is made. The method for manufacturing a wet rubber masterbatch associated with the first embodiment further comprises an operation in which the liquid mixture is coagulated to obtain a coagulum. The method for manufacturing a wet rubber masterbatch associated with the first embodiment further comprises an operation in which the coagulum is dewatered.

—Operation in which Latex is Prepared—

The operation in which the latex is prepared comprises a step in which diammonium phosphate is added to latex raw material. The operation in which the latex is prepared further comprises a step in which magnesium phosphate produced as a result of the step in which diammonium phosphate was added to latex raw material is removed. The operation in which the latex is prepared may further comprise a step in which stabilizer is added to the latex raw material.

The latex raw material might, for example, be liquid(s) extracted from rubber tree(s), field latex, and/or the like. Latex raw material comprises a nonrubber component. The nonrubber component might, for example, be magnesium, protein(s), and/or the like.

For every 100 parts by mass of latex raw material, it is preferred that diammonium phosphate be added in an amount that is not greater than 1.2 parts by mass, more preferred that this be not greater than 1.0 part by mass, and still more preferred that this be not greater than 0.8 part by mass. Above 1.2 parts by mass, there is a tendency for the 90 vol % particle diameter to exceed 2 μm. For every 100 parts by mass of latex raw material, the lower limit of the range in values for the amount of diammonium phosphate that is added might, for example, be 0.05 part by mass, 0.10 part by mass, or the like.

The stabilizer might, for example, be ammonia and/or other such alkali(s).

The latex obtained by the foregoing means comprises rubber particles for which the 90 vol % particle diameter is not greater than 2 μm. Above 2 μm, it will not be possible to achieve effective improvement with respect to reduction in heat generation. This is likely due to the fact that under such conditions it is speculated there would be nonuniform dispersion of carbon black. As examples of the lower limit of the range in values for the 90 vol % particle diameter, 1.0 μm, 1.1 μm, 1.2 μm, 1.3 μm, and so forth may be cited. Magnesium is present in the latex in an amount that is not greater than 150 ppm, it being preferred that this be not greater than 140 ppm, still more preferred that this be not greater than 130 ppm, and even still more preferred that this be not greater than 120 ppm. Above 150 ppm, it will not be possible to achieve effective improvement with respect to fatigue resistance and tensile characteristics. This is likely due to the fact that under such conditions it is speculated that there would be many crack initiation sites present throughout the vulcanized rubber and that there would be decrease in interaction between natural rubber and carbon black. As examples of the lower limit of the range in values for the amount of magnesium present in the latex, 40 ppm, 50 ppm, and so forth may be cited. The 90 vol % particle diameter and the magnesium content may be adjusted primarily through adjustment of the amount of diammonium phosphate that is added.

—Operation in which Liquid Mixture is Made—

The operation in which the liquid mixture is made comprises a step (a) in which the latex and a dispersion solvent are mixed together. The operation in which the liquid mixture is made further comprises a step (b) in which the latex solution obtained as a result of step (a) and a slurry that contains carbon black are mixed together.

The dispersion solvent might, for example, be water and/or other substance(s) that contain water and/or organic solvent. Among these, water is preferred.

The slurry comprises carbon black. The slurry further comprises dispersion solvent. The carbon black is dispersed in the slurry. The slurry may be made by causing the carbon black and the dispersion solvent to be mixed together.

As examples of the carbon black, besides SAF, ISAF, HAF, FEF, GPF, and other such carbon blacks ordinarily used in the rubber industry, acetylene black, Ketchen black, and/or other such electrically conductive carbon blacks may be used. The carbon black may be nongranulated carbon black or may be granulated carbon black that has been granulated based upon considerations related to the handling characteristics thereof as is ordinary practice in the rubber industry. It is preferred that the specific surface area as determined by nitrogen adsorption (N₂SA) of the carbon black be 20 m²/g to 160 m²/g.

It is preferred that the solids concentration, i.e., the content of the rubber component, in the latex solution be 10 mass % to 60 mass %, and more preferred that this be 20 mass % to 30 mass %.

As examples of the method for the mixing at step (b), agitation methods involving use of high-shear mixers, high shear mixers, homomixers, ball mills, bead mills, high-pressure homogenizers, ultrasonic homogenizers, colloid mills, and other such ordinary dispersers may be cited.

The liquid mixture obtained by the foregoing means comprises a rubber component and carbon black. The rubber component might, for example, be rubber particle(s).

For every 100 parts by mass of the rubber component, it is preferred that the amount of carbon black present in the liquid mixture be not less than 10 parts by mass, more preferred that this be not less than 20 parts by mass, and still more preferred that this be not less than 30 parts by mass. Below 10 parts by mass, there is a possibility that improvement of the properties of the vulcanized rubber will not be possible. For every 100 parts by mass of the rubber component, it is preferred that the amount of carbon black present therein be not greater than 120 parts by mass, more preferred that this be not greater than 100 parts by mass, still more preferred that this be not greater than 80 parts by mass, and even still more preferred that this be not greater than 70 parts by mass. Above 120 parts by mass, there is a possibility that improvement of the properties of the vulcanized rubber will not be possible. This is likely due to the fact that under such conditions it is speculated that there might be occurrence of poor dispersion of carbon black.

—Operation in which Liquid Mixture is Coagulated to Obtain Coagulum—

Coagulation of particles within the liquid mixture is carried out to obtain a coagulum. The method for causing coagulation might, for example, be a method in which coagulant(s) is/are added to the liquid mixture, a method in which the liquid mixture is agitated, and/or the like. As coagulant, acid may be cited as an example. The acid might, for example, be formic acid, sulfuric acid, and/or the like.

—Operation in which Coagulum is Dewatered—

Dewatering of the coagulum obtained by the foregoing means is carried out. As the dewatering method, dewatering methods involving use of single screw extruders, ovens, vacuum dryers, air dryers, and other such drying apparatuses may be cited as examples.

The method for manufacturing a wet rubber masterbatch associated with the first embodiment satisfies Formula I, below. Because Formula I is satisfied, it will be possible to achieve effective improvement with respect to fatigue resistance, reduction in heat generation, and tensile characteristics.

0.1<b/a<1.0 Formula I

At Formula I, a indicates amount (ppm) of magnesium present in latex; b indicates amount (parts by mass) of carbon black in the liquid mixture for every 100 parts by mass of rubber component in the liquid mixture.

It is preferred that the method for manufacturing a wet rubber masterbatch associated with the first embodiment satisfy Formula II, below. If Formula II is satisfied, it will be possible to achieve effective improvement with respect to reduction in heat generation. This is likely due to the fact that under such conditions it is speculated that the frequency of contact between carbon black and rubber particles would be high.

0.6<(b×d)/(c×1000)<5.7 Formula II

At Formula II, b indicates amount (parts by mass) of carbon black in the liquid mixture for every 100 parts by mass of rubber component in the liquid mixture; c indicates 90 vol % particle diameter (μm) of rubber particles within the latex; d indicates specific surface area (m²/g) as determined by nitrogen adsorption (N₂SA) of carbon black within the liquid mixture.

The wet rubber masterbatch obtained by means of the foregoing operation comprises natural rubber and carbon black. For every 100 parts by mass of natural rubber, it is preferred that the amount of carbon black present therein be not less than 10 parts by mass, more preferred that this be not less than 20 parts by mass, and still more preferred that this be not less than 30 parts by mass. For every 100 parts by mass of natural rubber, it is preferred that the amount of carbon black present therein be not greater than 120 parts by mass, more preferred that this be not greater than 100 parts by mass, and still more preferred that this be not greater than 80 parts by mass.

A method for manufacturing a rubber composition associated with the first embodiment comprises an operation in which wet rubber masterbatch and compounding ingredient(s) are kneaded together. As examples of compounding ingredients, zinc oxide, stearic acid, antioxidant, wax, oil, silane coupling agent, and so forth may be cited. Rubber may be added as necessary. As examples of rubber that may be added, natural rubber, isoprene rubber (IR), butadiene rubber (BR), styrene-butadiene rubber (SBR), styrene-isoprene rubber, butadiene-isoprene rubber, styrene-butadiene-isoprene rubber, nitrile rubber (NBR), chloroprene rubber (CR), butyl rubber (IIR), and so forth may be cited.

The method for manufacturing the rubber composition associated with the first embodiment further comprises an operation in which a mixture, i.e., the mixture obtained by means of the operation in which wet rubber masterbatch and compounding ingredient(s) are kneaded together, and vulcanizing-type compounding ingredient(s) are kneaded together. As examples of vulcanizing-type compounding ingredients, sulfur, organic peroxides, and other such vulcanizing agents, vulcanization accelerators, vulcanization accelerator activators, vulcanization retarders, and so forth may be cited. As examples of the sulfur, powdered sulfur, precipitated sulfur, insoluble sulfur, high dispersing sulfur, and the like may be cited. Based upon consideration of post-vulcanization rubber properties, endurance, and so forth, it is preferred that the amount of sulfur compounded therein, expressed as equivalent sulfur content, be 0.5 part by mass to 5.0 parts by mass for every 100 parts by mass of the rubber component. As examples of vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. For every 100 parts by mass of rubber component, it is preferred that the amount of vulcanization accelerator blended therein be 0.1 part by mass to 5.0 parts by mass.

The rubber composition obtained by means of the method associated with the first embodiment may be favorably employed in a tire, and may in particular be favorably employed in a pneumatic tire. The rubber composition may be favorably employed as a tread or other such tire member.

A rubber composition comprises rubber. The rubber comprises natural rubber originating from the wet rubber masterbatch. For every 100 mass % of the rubber, it is preferred that the amount of natural rubber originating from the wet rubber masterbatch that is present therein be not less than 10 mass %.

A method for manufacturing a tire associated with the first embodiment comprises an operation in which a green tire is made. The green tire comprises the rubber composition. The method for manufacturing the tire associated with the first embodiment further comprises an operation in which the green tire is heated.

### —Variation 1—

A slurry is made by means of a method comprising a step (I) in which dispersion solvent and a portion of the latex are mixed, and a step (II) in which the dilute latex solution obtained at step (I) and carbon black are mixed. Employment of step (I) will permit formation of an extremely thin latex phase on all or part of the surface of the carbon black, and will make it possible to prevent reflocculation of carbon black.

### WORKING EXAMPLES

Working examples and the like which illustrate the constitution and effect of the present invention in specific terms are described below. Raw materials employed were as follows.

Raw Materials Employed

| | |
|---|---|
| DAP | Diammonium hydrogen phosphate |
| | manufactured by Wako |
| | Pure Chemical Industries, Ltd. |
| Coagulant | Formic acid (reagent-grade 85%; |
| | diluted to obtain 10% solution; |
| | pH adjusted to 1.2) manufactured |
| | by Nacalai Tesque, Inc. |
| Carbon Black (A) | “SEAST 9” manufactured |
| | by Tokai Carbon Co., Ltd. |
| Carbon Black (B) | “SEAST V” manufactured |
| | by Tokai Carbon Co., Ltd. |
| Zinc oxide | “Zinc Oxide No. 1” |
| | manufactured by Mitsui |
| | Mining & Smelting Co., Ltd. |
| Stearic acid | “LUNAC S-20” manufactured |
| | by Kao Corporation |
| Antioxidant (A) | “NOCRAC 6C” manufactured |
| | by Ouchi Shinko Chemical |
| | Industrial Co., Ltd. |
| Antioxidant (B) | “RD” manufactured by Ouchi |
| | Shinko Chemical Industrial Co., Ltd. |
| Sulfur | “Powdered Sulfur” |
| | manufactured by Tsurumi Chemical |
| | Industry Co., Ltd. |
| Vulcanization accelerator | “NOCCELER NS-P” |
| | manufactured by Ouchi Shinko |
| | Chemical Industrial Co., Ltd. |

### Comparative Example 1

### —Manufacture of Wet Rubber Masterbatch—

Natural rubber latex was collected. Water was added to natural rubber latex to manufacture a natural rubber latex solution having a solids (rubber) concentration that was 27 mass %. 55 parts by mass of Carbon Black (A) was added to water. An agitator (Flashblend manufactured by Silverson) was used to disperse the Carbon Black (A) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 2

### —Manufacture of Natural Rubber—

Natural rubber latex was collected. DAP as a fraction of the total weight of the natural rubber latex was added in the amount shown at TABLE 1, and the magnesium phosphate which precipitated was removed therefrom to obtain a liquid supernatant. The liquid supernatant was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture natural rubber.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 3 and Working Examples 1-3

### —Manufacture of Wet Rubber Masterbatch—

Natural rubber latex was collected. DAP as a fraction of the total weight of the natural rubber latex was added in the amount shown at TABLE 1, and the magnesium phosphate which precipitated was removed therefrom to obtain a liquid supernatant. Water was added to the liquid supernatant to manufacture a natural rubber latex solution having a solids (rubber) concentration that was 27 mass %. 55 parts by mass of Carbon Black (A) was added to water. An agitator (Flashblend manufactured by Silverson) was used to disperse the Carbon Black (A) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### First Evaluation

### —Magnesium Content—

Magnesium content of liquid supernatant—Comparative Examples 2-3 and Working Examples 1-3—was measured in accordance with ISO 11852; 2011. Magnesium content of natural rubber latex—Comparative Example 1—was measured in accordance with ISO 11852; 2011.

### —90 Vol % Particle Diameter—

D90 (μm) of liquid supernatant—Comparative Examples 2-3 and Working Examples 1-3—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Example 1—was measured under the same conditions.

### Second Evaluation: Properties of Vulcanized Rubber

The rubber composition was vulcanized at conditions of 150° C. for 30 min to obtain vulcanized rubber. Fatigue resistance, heat generation, and tensile stress of the vulcanized rubber were evaluated. Conditions under which evaluation was performed are as indicated below. Results are shown in TABLE 1.

### —Fatigue Resistance—

Performance of vulcanized rubber with respect to fatigue resistance was evaluated in accordance with JIS K 6260 (flex cracking testing). Results of evaluation are shown as indexed relative to a value of 100 for Comparative Example 1. This means that the larger the value the more excellent it was in terms of performance with respect to fatigue resistance.

### —Heat Generation—

Heat generation of vulcanized rubber was evaluated using loss tangent tans in accordance with JIS K 6265. Measurements were carried out under conditions of 50 Hz, 80° C., and dynamic strain 2% using an E4000 rheospectrometer manufactured by UBM. Results of evaluation are shown as indexed relative to a value of 100 for Comparative Example 1. This means that the smaller the value the lower—and thus the better—was the heat generation.

### —Tensile Stress—

Tensile stress was evaluated at an elongation of 300% (hereinafter “M300”) in accordance with JIS K 6261. Results of evaluation are shown as indexed relative to a value of 100 for Comparative Example 1. This means that the larger the value the more excellent it was with respect to tensile stress.

TABLE 1

| | | | | | |
|---|---|---|---|---|---|
| Comparative | Comparative | Comparative | Working | Working | Working |
| Example 1 | Example 2 | Example 3 | Example 1 | Example 2 | Example 3 |

Liquid supernatant or natural rubber latex

| Amount of DAP added | | — | 0.8 | 1.5 | 0.25 | 0.4 | 0.9 |
|---|---|---|---|---|---|---|---|
| mass % | | | | | | | |
| Evaluation | Magnesium | — | 110 | 50 | 144 | 131 | 101 |
| | content of liquid | | | | | | |
| | supernatant | | | | | | |
| | ppm | | | | | | |
| | D90 particle | — | 1.53 | 3.80 | 1.29 | 1.40 | 1.60 |
| | diameter of | | | | | | |
| | rubber particles | | | | | | |
| | within liquid | | | | | | |
| | supernatant μm | | | | | | |
| | Magnesium | 180 | — | — | — | — | — |
| | content of | | | | | | |
| | natural rubber | | | | | | |
| | latex ppm | | | | | | |
| | D90 particle | 1.20 | — | — | — | — | — |
| | diameter of | | | | | | |
| | rubber particles | | | | | | |
| | within natural | | | | | | |
| | rubber latex μm | | | | | | |

Pre-coagulation liquid mixture

| | | | | | | | |
|---|---|---|---|---|---|---|---|
| Blended | Natural rubber | 100 | — | 100 | 100 | 100 | 100 |
| amount | Carbon Black | 55 | — | 55 | 55 | 55 | 55 |
| (parts by | (A) | | | | | | |
| mass) | | | | | | | |

| | | | | | | |
|---|---|---|---|---|---|---|
| N₂SA of Carbon Black (A) | 142 | — | 142 | 142 | 142 | 142 |
| m²/g | | | | | | |

Conditions

| | | | | | | |
|---|---|---|---|---|---|---|
| b/a | 0.31 | — | 1.10 | 0.38 | 0.42 | 0.54 |
| (b × d)/(c × 1000) | 6.51 | — | 2.06 | 6.05 | 5.58 | 4.88 |

Wet rubber masterbatch

| | | | | | | | |
|---|---|---|---|---|---|---|---|
| Blended | Natural rubber | 100 | — | 100 | 100 | 100 | 100 |
| amount | Carbon Black | 55 | — | 55 | 55 | 55 | 55 |
| (parts by | (A) | | | | | | |
| mass) | | | | | | | |

Rubber composition

| | | | | | | | |
|---|---|---|---|---|---|---|---|
| Blended | Wet rubber | 155 | — | 155 | 155 | 155 | 155 |
| amount | masterbatch | | | | | | |
| (parts by | Natural rubber | — | 100 | — | — | — | — |
| mass) | Carbon Black | — | 55 | — | — | — | — |
| | (A) | | | | | | |
| | Zinc oxide | 3 | 3 | 3 | 3 | 3 | 3 |
| | Stearic acid | 4 | 4 | 4 | 4 | 4 | 4 |
| | Antioxidant (A) | 2 | 2 | 2 | 2 | 2 | 2 |
| | Antioxidant (B) | 1 | 1 | 1 | 1 | 1 | 1 |
| | Sulfur | 2 | 2 | 2 | 2 | 2 | 2 |
| | Vulcanization | 1 | 1 | 1 | 1 | 1 | 1 |
| | accelerator | | | | | | |

Vulcanized rubber

| | | | | | | | |
|---|---|---|---|---|---|---|---|
| Evaluation | Fatigue | 100 | 75 | 96 | 113 | 116 | 120 |
| | resistance | | | | | | |
| | (relative to | | | | | | |
| | index value) | | | | | | |
| | Heat generation | 100 | 113 | 111 | 98 | 94 | 92 |
| | (relative to | | | | | | |
| | index value) | | | | | | |
| | M300 (relative | 100 | 93 | 92 | 107 | 111 | 113 |
| | to index value) | | | | | | |

At Working Example 1, where DAP was 0.25 mass %, fatigue resistance, ability to achieve reduced heat generation, and tensile stress were better than at Comparative Example 1.

At Working Example 2, where DAP was 0.4 mass %, fatigue resistance, ability to achieve reduced heat generation, and tensile stress were better than at Working Example 1. And at Working Example 3 as well, where DAP was 0.9 mass %, fatigue resistance, ability to achieve reduced heat generation, and tensile stress were better than at Working Example 1. At Working Examples 2-3, it is speculated that the frequency of contact between Carbon Black (A) and rubber particles was high.

At Comparative Example 3, where DAP was 1.5 mass %, fatigue resistance, ability to achieve reduced heat generation, and tensile stress were worse than at Comparative Example 1. It is speculated that there may have been increased tendency for agglomeration to occur due to the fact that particle diameter of rubber particles was too large.

At Comparative Example 2, Comparative Example 2 being an example in which dry-blending was carried out, fatigue resistance, ability to achieve reduced heat generation, and tensile stress were worse than at Comparative Example 1.

### Comparative Example 4

### —Manufacture of Wet Rubber Masterbatch—

Natural rubber latex was collected. Water was added to natural rubber latex to manufacture a natural rubber latex solution having a solids (rubber) concentration that was 27 mass %. 40 parts by mass of Carbon Black (B) was added to water. An agitator (Flashblend manufactured by Silverson) was used to disperse the Carbon Black (B) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 2, and a Model B Banbury mixer manufactured by Kobe Steel, Ltd., was used to knead these together to manufacture a rubber composition.

### Working Examples 4-5

### —Manufacture of Wet Rubber Masterbatch—

Natural rubber latex was collected. DAP as a fraction of the total weight of the natural rubber latex was added in the amount shown at TABLE 2, and the magnesium phosphate which precipitated was removed therefrom to obtain a liquid supernatant. Water was added to the liquid supernatant to manufacture a natural rubber latex solution having a solids (rubber) concentration that was 27 mass %. 40 parts by mass of Carbon Black (B) was added to water. An agitator (Flashblend manufactured by Silverson) was used to disperse the Carbon Black (B) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 2, and a Model B Banbury mixer manufactured by Kobe Steel, Ltd., was used to knead these together to manufacture a rubber composition.

### First Evaluation

### —Magnesium Content—

Magnesium content of liquid supernatant—Working Examples 4-5—was measured in accordance with ISO 11852; 2011. Magnesium content of natural rubber latex—Comparative Example 4—was measured in accordance with ISO 11852; 2011.

### —90 Vol % Particle Diameter—

D90 (μm) of liquid supernatant—Working Examples 4-5—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Example 4—was measured under the same conditions.

### Second Evaluation: Properties of Vulcanized Rubber

The rubber composition was vulcanized at conditions of 150° C. for 30 min to obtain vulcanized rubber. Fatigue resistance, heat generation, and tensile stress of the vulcanized rubber were evaluated. Conditions under which evaluation was performed were identical to those at Working Example 1. Results of evaluation are shown as indexed relative to a value of 100 for Comparative Example 4.

TABLE 2

| | | |
|---|---|---|
| Comparative | Working | Working |
| Example 4 | Example 4 | Example 5 |

Liquid supernatant or natural rubber latex

| Amount of DAP added mass % | | — | 1.1 | 0.4 |
|---|---|---|---|---|
| Evaluation | Magnesium content | — | 80 | 131 |
| | of liquid | | | |
| | supernatant ppm | | | |
| | D90 particle | — | 1.92 | 1.40 |
| | diameter of | | | |
| | rubber particles | | | |
| | within liquid | | | |
| | supernatant μm | | | |
| | Magnesium content | 180 | — | — |
| | of natural rubber | | | |
| | latex ppm | | | |
| | D90 particle | 1.20 | — | — |
| | diameter of | | | |
| | rubber particles | | | |
| | within natural | | | |
| | rubber latex μm | | | |

Pre-coagulation liquid mixture

| | | | | |
|---|---|---|---|---|
| Blended | Natural rubber | 100 | 100 | 100 |
| amount | Carbon | 40 | 40 | 40 |
| (parts | Black (B) | | | |
| by mass) | | | | |

| | | | |
|---|---|---|---|
| N₂SA of Carbon | 27 | 27 | 27 |
| Black (B) m²/g | | | |

Conditions

| | | | |
|---|---|---|---|
| b/a | 0.22 | 0.50 | 0.31 |
| (b × d)/(c × 1000) | 0.90 | 0.56 | 0.77 |

Wet rubber masterbatch

| | | | | |
|---|---|---|---|---|
| Blended | Natural rubber | 100 | 100 | 100 |
| amount | Carbon | 40 | 40 | 40 |
| (parts | Black (B) | | | |
| by mass) | | | | |

Rubber composition

| | | | | |
|---|---|---|---|---|
| Blended | Wet rubber | 140 | 140 | 140 |
| amount | masterbatch | | | |
| (parts | Zinc oxide | 3 | 3 | 3 |
| by mass) | Stearic acid | 4 | 4 | 4 |
| | Antioxidant (A) | 2 | 2 | 2 |
| | Antioxidant (B) | 1 | 1 | 1 |
| | Sulfur | 2 | 2 | 2 |
| | Vulcanization | 1 | 1 | 1 |
| | accelerator | | | |

Vulcanized rubber

| | | | | |
|---|---|---|---|---|
| Evaluation | Fatigue | 100 | 118 | 111 |
| | resistance | | | |
| | (relative to | | | |
| | index value) | | | |
| | Heat generation | 100 | 97 | 92 |
| | (relative to | | | |
| | index value) | | | |
| | M300 (relative | 100 | 109 | 105 |
| | to index value) | | | |

At Working Example 4, where DAP was 1.1 mass %, fatigue resistance, ability to achieve reduced heat generation, and tensile stress were better than at Comparative Example 4. At Working Example 5, where DAP was 0.4 mass %, ability to achieve reduced heat generation was better than at Working Example 4. At Working Example 5, it is speculated that the frequency of contact between Carbon Black (B) and rubber particles was high.

### Comparative Example 5

### —Manufacture of Wet Rubber Masterbatch—

Natural rubber latex was collected. Water was added to natural rubber latex to manufacture a natural rubber latex solution having a solids (rubber) concentration that was 27 mass %. 70 parts by mass of Carbon Black (A) was added to water. An agitator (Flashblend manufactured by Silverson) was used to disperse the Carbon Black (A) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 3, and a Model B Banbury mixer manufactured by Kobe Steel, Ltd., was used to knead these together to manufacture a rubber composition.

### Working Examples 6-7

### —Manufacture of Wet Rubber Masterbatch—

Natural rubber latex was collected. DAP as a fraction of the total weight of the natural rubber latex was added in the amount shown at TABLE 3, and the magnesium phosphate which precipitated was removed therefrom to obtain a liquid supernatant. Water was added to the liquid supernatant to manufacture a natural rubber latex solution having a solids (rubber) concentration that was 27 mass %. 70 parts by mass of Carbon Black (A) was added to water. An agitator (Flashblend manufactured by Silverson) was used to disperse the Carbon Black (A) (Flashblend conditions: 3600 rpm; 30 min) to manufacture a carbon black slurry. The natural rubber latex solution was added to the carbon black slurry in such amount as to cause solids (rubber) to be present therein in an amount that was 100 parts by mass to manufacture a pre-coagulation liquid mixture. The pre-coagulation liquid mixture was maintained at 90° C. in a mixer (SMV-20 Supermixer manufactured by Kawata Co., Ltd.) while formic acid was added thereto in an amount sufficient to achieve a pH of 4. A squeezer-type single-screw dewatering extruder (Model V-02 screw press manufactured by Suehiro EPM Corporation) was used to dry the coagulum until water content was not greater than 1.5% to manufacture a wet rubber masterbatch.

### —Manufacture of Rubber Composition—

The respective compounding ingredients were blended in amounts as listed at TABLE 3, and a Model B Banbury mixer manufactured by Kobe Steel, Ltd., was used to knead these together to manufacture a rubber composition.

### First Evaluation

### —Magnesium Content—

Magnesium content of liquid supernatant—Working Examples 6-7—was measured in accordance with ISO 11852; 2011. Magnesium content of natural rubber latex—Comparative Example 5—was measured in accordance with ISO 11852; 2011.

### —90 Vol % Particle Diameter—

D90 (μm) of liquid supernatant—Working Examples 6-7—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Example 5—was measured under the same conditions.

### Second Evaluation: Properties of Vulcanized Rubber

The rubber composition was vulcanized at conditions of 150° C. for 30 min to obtain vulcanized rubber. Fatigue resistance, heat generation, and tensile stress of the vulcanized rubber were evaluated. Conditions under which evaluation was performed were identical to those at Working Example 1. Results of evaluation are shown as indexed relative to a value of 100 for Comparative Example 5.

TABLE 3

| | | |
|---|---|---|
| Comparative | Working | Working |
| Example 5 | Example 6 | Example 7 |

Liquid supernatant or natural rubber latex

| Amount of DAP added mass % | | — | 0.25 | 1.1 |
|---|---|---|---|---|
| Evaluation | Magnesium content | — | 144 | 80 |
| | of liquid | | | |
| | supernatant ppm | | | |
| | D90 particle | — | 1.29 | 1.92 |
| | diameter of | | | |
| | rubber particles | | | |
| | within liquid | | | |
| | supernatant μm | | | |
| | Magnesium content | 180 | — | — |
| | of natural | | | |
| | rubber latex ppm | | | |
| | D90 particle | 1.20 | — | — |
| | diameter of | | | |
| | rubber particles | | | |
| | within natural | | | |
| | rubber latex μm | | | |

Pre-coagulation liquid mixture

| | | | | |
|---|---|---|---|---|
| Blended | Natural rubber | 100 | 100 | 100 |
| amount | Carbon | 70 | 70 | 70 |
| (parts | Black (A) | | | |
| by mass) | | | | |

| | | | |
|---|---|---|---|
| N₂SA of Carbon | 142 | 142 | 142 |
| Black (A) m²/g | | | |

Conditions

| | | | |
|---|---|---|---|
| b/a | 0.39 | 0.49 | 0.88 |
| (b × d)/(c × 1000) | 8.28 | 7.71 | 5.18 |

Wet rubber masterbatch

| | | | | |
|---|---|---|---|---|
| Blended | Natural rubber | 100 | 100 | 100 |
| amount | Carbon | 70 | 70 | 70 |
| (parts | Black (A) | | | |
| by mass) | | | | |

Rubber composition

| | | | | |
|---|---|---|---|---|
| Blended | Wet rubber | 170 | 170 | 170 |
| amount | masterbatch | | | |
| (parts | Zinc oxide | 3 | 3 | 3 |
| by mass) | Stearic acid | 4 | 4 | 4 |
| | Antioxidant (A) | 2 | 2 | 2 |
| | Antioxidant (B) | 1 | 1 | 1 |
| | Sulfur | 2 | 2 | 2 |
| | Vulcanization | 1 | 1 | 1 |
| | accelerator | | | |

Vulcanized rubber

| | | | | |
|---|---|---|---|---|
| Evaluation | Fatigue | 100 | 110 | 118 |
| | resistance | | | |
| | (relative to | | | |
| | index value) | | | |
| | Heat | 100 | 98 | 93 |
| | generation | | | |
| | (relative to | | | |
| | index value) | | | |
| | M300 (relative | 100 | 113 | 115 |
| | to index value) | | | |

At Working Example 6, where DAP was 0.25 mass %, fatigue resistance, ability to achieve reduced heat generation, and tensile stress were better than at Comparative Example 5. At Working Example 7, where DAP was 1.1 mass %, ability to achieve reduced heat generation was better than at Working Example 6. At Working Example 7, it is speculated that the frequency of contact between Carbon Black (A) and rubber particles was high.

1. A method for manufacturing a wet rubber masterbatch satisfying Formula I, below, the method comprising:
an operation in which a latex that comprises rubber particles for which 90 vol % particle diameter is not greater than 2 μm and that has magnesium present therein in an amount which is not greater than 150 ppm is prepared; and
an operation in which a liquid mixture that comprises a rubber component and carbon black is made;
wherein the operation in which the liquid mixture is made comprises a step (a) in which the latex and a dispersion solvent are mixed; and a step (b) in which a latex solution obtained at the foregoing step (a) and a slurry containing the carbon black are mixed;
wherein Formula I is given by
0.1<b/a<1.0; and
wherein, at Formula I, a indicates amount, expressed in units of ppm, of magnesium present in the latex; and b indicates amount, expressed in units of parts by mass, of the carbon black in the liquid mixture for every 100 parts by mass of the rubber component in the liquid mixture.

2. The method for manufacturing the wet rubber masterbatch according to claim 1 wherein the operation in which the latex is prepared comprises
a step in which diammonium phosphate is added to latex raw material; and
a step in which magnesium phosphate produced as a result of the foregoing step is removed.

3. A rubber composition manufacturing method comprising the method for manufacturing the wet rubber masterbatch according to claim 1.

4. A tire manufacturing method comprising the method for manufacturing the wet rubber masterbatch according to claim 1.

5. The method for manufacturing the wet rubber masterbatch according to claim 1 further comprising an operation in which the liquid mixture is coagulated to obtain a coagulum.

6. The method for manufacturing the wet rubber masterbatch according to claim 5 further comprising an operation in which the coagulum is dewatered.

7. The method for manufacturing the wet rubber masterbatch according to claim 1 wherein the 90 vol % particle diameter is not less than 1.0 μm.

8. The method for manufacturing the wet rubber masterbatch according to claim 1 wherein the magnesium is present therein in an amount which is not less than 40 ppm.

9. The method for manufacturing the wet rubber masterbatch according to claim 1 wherein the dispersion solvent comprises water.

10. The method for manufacturing the wet rubber masterbatch according to claim 1 wherein the latex is natural rubber latex.
